(19) United States
(12) Patent Application Publication
(10) Pub. No.: US 2005/0283422 A1
(43) Pub. Date: Dec. 22, 2005

(54) Centralized electronic currency trading exchange

(76) Inventor: David Myr, Jerusalem (IL)

Correspondence Address: NEIFELD IP LAW, PC, 4813-B EISENHOWER AVENUE, ALEXANDRIA, VA, 22304, US

(21) Appl. No.: 10/867,729

(22) Filed: Jun. 16, 2004

(51) Int. Cl. G06F 17/60

(52) U.S. Cl. 705/37

(57) ABSTRACT

The invention is a system, method and computer software application for electronic currency trading exchange. It creates a centralized electronic marketplace for currency trading in which a central processing server automatically matches buy and sell orders for a plurality of currency pairs, and where trades registration, clearing and settlement are centrally performed. The invention further provides a method of presentation of foreign exchange currency buy/sell orders and executed trades data displayed by means of graphical user interfaces for showing buy/sell orders prices for all price levels and executed trades prices and volumes. Government central banks, commercial banks and selected brokers-dealers worldwide will participate in trading as Exchange Members of the trading exchange thus enabling them to trade with each other on one centralized currency trading marketplace. Other brokers-dealers and individual traders will trade on the exchange by establishing business relations and signing special agreements with Exchange Members. Exchange Members and other exchange traders will receive a computer software application with an Orders graphic user interface for sending buy and sell orders to the disclosed system. Trades will be created by matching the orders, they will be registered on the on the system's central processing server and then will be transferred for clearing and settlement. Trades details will be disseminated to Exchange Members and then further to their clients and correspondents.

### REFERENCE TO RELATED APPLICATION

This application is related to the following patent application, incorporated by reference herein:
Application Ser. No. 10/613,467, filed on Jul. 3, 2003, entitled “MACHINE LEARNING AUTOMATIC ORDER TRANSMISSION SYSTEM FOR SENDING SELF-OPTIMIZED TRADING SIGNALS”, filed by David Myr and assigned to Makor Issues & Rights Ltd.

### REFERENCES CITED

### U.S. Patent Documents

U.S. Pat. No. 4,412,287, Automated stock exchange, Oct. 25, 1983
U.S. Pat. No. 4,674,044, Automated securities trading system, Jun. 16, 1987
U.S. Pat. No. 6,195,647, On-line transaction processing system for security trading, Feb. 27, 2001

### Other References

Reuters Dealing 3000 platform: http://about.reuters.com/productinfo/dealing3000/
EBS Spot platform: http://www.ebs.com/products/spot.asp?code=eu&
Currenex platform: http://www.currenex.com/
FxAll platform: http://www.fxall.com/
HotSpot platform: http://www.hotspotfx.com/
FXConnect platform: http://www.statestreet.com/capabilities/trading_services/products/ts_{—}073_fx_connect.html
Inventor: David Myr (Jerusalem, Israel).
Assignee: Makor Issues & Rights Ltd (Jerusalem, Israel).

### Relevant Terms and Definitions

“Ask” or “Ask price” or “Offer” is the lowest price at which any Buyer is willing to Sell a given currency pair.

“Bid” or “Bid price” is the highest price any Buyer is willing to pay for a given currency pair.

“Central Bank” is a governmental organization that manages country's monetary policy and regulates the financial institutions.

“Clearing” means the process of settling a trade.

“Currency Pair” means two currencies that make up a foreign exchange rate (e.g. EUR/USD).

“Execution” refers to completion of an order to buy or sell a currency pair.

“Exchange” means a national, regional, or worldwide computerized marketplace where securities can be traded including for example, NASDAQ or FOREX.

“Foreign Exchange” or “Forex” transaction means simultaneous buying of one currency and selling of another. Forex trading activities may be further classified into Spot and Forward trading.

“Forward” transactions mean a future currency delivery date.

“Long” is the position of buying (owning) a currency pair.

“Margin” means the amount of money deposited as collateral to cover potential losses.

“Member” means an Exchange Member admitted to membership under current invention and regulated according to it Central Bank rules and regulations.

“Orders” are electronic customer instructions for purchase or sale of currency pairs.

“Pip” is the smallest incremental move in a currency pair price (0.0001 for EUR/USD).

“Quote” means the Best Bid or Best Ask price available for a currency pair.

“Settlement” is the actual delivery of currencies made on the maturity date of a trade.

“Short” is the position of having sold a currency pair without buying it first.

“Spot” trading means an actual exchange of currencies.

“Spread” or “Bid/Ask Spread” is the pips difference between the Bid and Ask price.

“Volume” means the number, or money value, of currencies traded.

### DESCRIPTION OF THE INVENTION

1. Field of the Invention

This invention relates generally to the field of electronic financial transaction systems, and in particular to online computer methods, software applications and systems for conducting electronic foreign exchange transactions.

2. Background of the Invention

The foreign exchange market (Forex) provides a global scene to worldwide financial institutions to Buy and Sell foreign currencies, if necessary in very large amounts. Forex market is the largest financial marketplace in the world today with daily average turnover of over $US 1.5 trillion with its main trading centers in London, New York and Tokyo. The foreign exchange market is an ‘over the counter’ (OTC) market which means that there is no central exchange and clearing house where orders are matched. Trading in Forex is not centralized on an exchange, as with the stock and futures markets.

Forex trading has evolved a great deal in the past five years. Availability of online data provided traders with real-time market information in a matter of seconds or even milliseconds thus providing rapid trading order execution. Similarly to stock markets, it became largely a computer-based operation. Most Forex trading firms are offering now online trading platforms enabling their clients to deal online. Multibank trading platforms and electronic brokerage systems constitute a further Forex market evolvement.

Since Forex market is decentralized, there are many Forex brokers-dealers who act as market makers, i.e. they quote their own Best Bid/Best Ask prices which sometimes differ considerably from broker to broker. As a result, Forex prices for any currency pair at any particular point of time may be quite different depending on the broker firm making the market. On the other hand, in centralized markets, like the NASDAQ, any stock traded on the NASDAQ can only have one bid-ask quote at any given point of time.

Forex Market Participants

There are six main types of participants in the Forex market.
The Government Central Banks that play a major role in the foreign exchange markets. Central Banks have very substantial foreign exchange reserves making their intervention power significant. Central Banks generally let the market determine the value of the respective currencies but sometimes the Central Bank will intervene to buy or sell local currencies if they believe it is substantially under or overvalued and that it is having a negative effect on the economy. Additionally, some Central Banks restrain the market in times of excessive exchange rate volatility.
Commercial banks that are the largest Forex market participants. They deal with other banks and financial institutions in order to provide their clients with foreign currencies on the most competitive pricing.
Money managers and institutional investors. Growing by the month, there are thousands of investment companies, money managers, hedge and mutual funds managers dealing in Forex. Each investment company usually trades on the market for hundreds of their clients.
Individual traders. More and more individual traders are turning to Forex market as a source of speculation or capital preservation. Large liquidity and improving transparency as well as electronic trading tools contribute to widely increasing number of Forex traders and daytraders.
Large corporations worldwide, trade on Forex due to multinational and multicurrency nature of their business. These companies are normally generating a limited number of transactions, each one for a very large amount.
Forex brokers-dealers. The broker charges its clients with a commission for its services. Broker-dealer usually finds on a multibank market the highest bid and the lowest ask for the currency pair and buy the currency pair with the spread lower than they charge their clients with.
   Current Forex Trading Systems

There are several levels in current Forex market hierarchy each offering their own trading platforms. At the top of the hierarchy is the interbank market where the biggest banks in the world deal with each other directly or through electronic brokering systems like Reuters Dealing 3000 or EBS Spot. The interbank market is a credit-approved system where banks trade based solely on the credit relationships they have established with one another, i.e. in order to make a trade between them two banks must have a specific credit relationship with each other. There is no one centrally determined price for the currency in interbank market as the prices can differ from deal to deal, i.e. there could be two deals made on the same currency at the same time but with different prices. Another disadvantage of such system is in lack of its transparency, i.e. there are no central Bid/Ask orders shown on the system and available to all participants. Additionally, unlike the disclosed system, both Reuters Dealing 3000 and EBS Spot platforms don't provide neither all other Bid/Ask price tiers with their money/lot amount at each tier, identification of sides placing Bids/Asks or trades volume for the transactions done.

Second hierarchical level of Forex market consists of relatively newly established multibank trading platforms. Most known of them are Currenex, FxAll, Hotspot and FxConnect platforms. Bids/Asks prices on these platforms are provided by one or more banks participating in such platforms. Trading on multibank platform depends on finding a so-called “Prime Brokerage” bank for opening a credit line and establishing credit relationship with several participating third-party banks in order to trade with them on a multibank platform. The trader trades then with third-party counterpart banks on a Prime Brokerage bank behalf. Every trade is settled then between Prime Brokerage bank and third-party bank. Trades are executed by sending an order to one of the participating third-party banks. There is no central order matching on these platforms. As a result, sometimes a negative spread or a zero spread appears in one or several currency pairs. I.e., there is a Bid for a particular currency pair higher or equal to the Ask which is impossible and illogical for centrally-matched exchange where the trade is done when Bid equals to the Asks and all unmatched Bids are lower than every unmatched Ask. Additionally, unlike the disclosed system, the multibank platforms provide only Best Bid/Best Bid information and provide neither Bid/Ask data for all price tiers with their money/lot amount at each tier, identification of sides placing Bids/Asks or trades volume for the transactions done.

Third level of Forex market participants are online brokers—market makers that normally trade on Forex through one or more large commercial banks. Market makers quote in their electronic trading platforms only the Best Bid/Best Ask price information according to which their clients are trading. Market makers determine Best Bid or Best Ask according to their own supply/demand situation and it may differ significantly from one market maker to another.

Fourths level—the retail market—trading individuals, corporations and institutional investors do not have access to the competitive rates of interbank and are required to pay significantly larger Bid-Ask spread in every transaction they make. These retail traders deal through just one or a few banks or brokers since they have to establish a credit line with each bank/broker that they want to trade through. As a result, retail traders receive much less competitive rates than higher hierarchy traders and pay higher Bid/Ask spreads.

There are some trading methods and systems in other fields of financial securities, such as the ones disclosed in U.S. Pat. No. 4,412,287, Automated stock exchange, Oct. 25, 1983; U.S. Pat. No. 4,674,044, Automated securities trading system, Jun. 16, 1987 and U.S. Pat. No. 6,195,647, On-line transaction processing system for security trading, Feb. 27, 2001. None of these systems regard to currency trading specifics and elements particular to the Forex market.

Need for the Disclosed System

Until today, many foreign exchange deals have been done between participants on the basis of trust and reputation to deliver on an agreement.

Forex currency rates differ from broker to broker and from bank to bank. There are centrally provided indicative rates but each broker and bank can alter the rates according to his own supply/demand situation. As a result there are different rates for the same currency pair at a single point of time. Furthermore, retail customers are forced to trade on worse conditions than larger traders and institutions. To eliminate such a discrepancy in prices and to level up currency trading field a centralized foreign exchange market is needed.

Multibank trading platforms provide some kind of centralization for Forex market but they don't provide the full and transparent Bids/Asks picture with trades details, volume, executing banks details, and are limited to large bank and corporate customers by setting a minimum monthly dealing volume of hundreds millions of dollars.

To eliminate the above mentioned disadvantages of a current Forex marketplace, there is a strong need for creating a centralized foreign exchange marketplace with one centrally determined price for every currency pair, central clearing and settlement, where the traders could view the full depth of Bid/Ask supply/demand situation and executed trades situation—all of which would support and inform traders for better trading decisions.

### BRIEF DESCRIPTION OF THE FIGURES

FIG. 1 presents a graphical overview of different levels of system participants and relations between them;

FIG. 2 provides a general overview of the major data streams of the invented system;

FIG. 3 provides a graphical overview of a Central Clearing and Settlement Banking System;

FIG. 4 provides a flowchart describing a Exchange Member Clearing and Settlement System;

FIG. 5 presents a flowchart where graphic user interface for showing bids and asks data is provided;

FIG. 6 provides a flowchart describing order sending and execution options available in the system and computer software application;

FIG. 7 illustrates a graphical user interface for showing executed trades data;

FIG. 8 presents a flowchart where graphical user interface for showing trades prices and particulars data.

### SYSTEM PARTICIPANTS

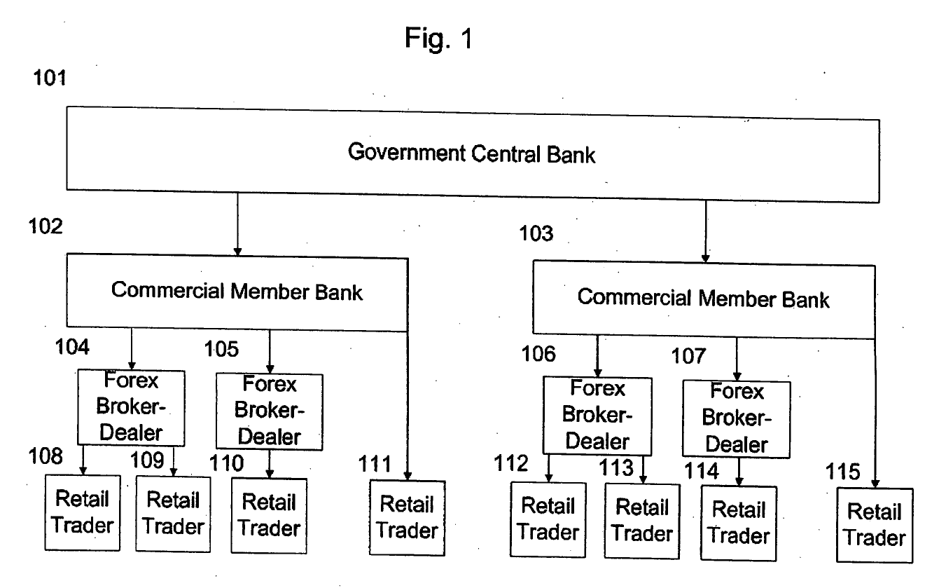

The system will have three hierarchical levels of vertically graduated participants, each one with his own set of permissions, duties and rights. Every participant, regardless of his level, will receive a trading software application from which the participants will view a full array of currency pricing information available on the system: all deals made on all currency pairs available on the system through the Trades and Prices Windows as well as all Bid/Ask pricing information displayed on the Bids/Asks Window. From this software application, the participants will have an ability to send Buy/Sell orders according to the pricing information and personal considerations by clicking on an appropriate Bid/Ask quotation or by submitting all relevant order information in the Orders, Trades or Prices Windows. Different levels of system participants and relations between them are illustrated by the flowchart in FIG. 1.
a. Exchange Members (101). In order to become an Exchange Member, each commercial bank and Forex broker-dealer will have to apply for the exchange membership, should have a valid bank license from his Government Central Bank and comply with various Central Bank regulations as well as to satisfy all system-defined requirements.
   Additionally, in case of intervention or other cases requiring his participation in currency trading, each Central Bank could participate in the system as one of the Exchange Members by transmitting its buy/sell orders to the system's central processing server.
   The Exchange Member will sign a correspondent agreement with one or more non-member commercial banks and Forex brokers-dealers. According to these agreements, the bank will be responsible for non-member bank and Forex broker compliance with all system regulations.
   The Exchange Member will provide it clients (correspondents) with a credit line to enable them margin trading. Each Exchange Member will be provided with a special Member-Clients Module for accounting of his clients' activities.
   Each Exchange Member will be assigned a unique system Member ID that will be displayed on a Bids/Asks Window as well as on a Trades Window of the system's trading software application. Exchange Member's Member ID will appear in each buy/sell order entered by Exchange Member's correspondents and clients. Exchange Members' Buy Member ID and/or a Sell Member ID will be displayed on a Trades Window for every trade in which this Exchange Member's correspondents participated on a buy or a sell side.
   The Exchange Member will provide a trading software application to it clients to enable them to enter buy/sell orders into the system and a Non-Member Order Entry Module to the non-member banks/brokers to provide the latter with the means for entering/editing their clients' orders.
   For every order entered into the system by Exchange Member's clients, the bank will receive a per-volume and/or per-transaction fee. Each Exchange Member will be provided with a special Member Order Entry Module, different from an interface that regular traders will be provided with. This module will enable Exchange Members to enter buy/sell orders of its clients into the system as well as changing or canceling an existing client's order entered into the system.
b. Non-member banks/brokers-dealers (102-104). In order to trade on the exchange, the non-member commercial banks and brokers-dealers will have to sign a special non-member correspondent agreement with one or more Exchange Members. Those Exchange Members will be responsible for inspecting each such bank's/broker's financial stability and compliance with all system-defined requirements as well as with its own Forex-related regulations. Additionally, non-member banks may sign a special agreements with non-member brokers and to act as an intermediary on the route between the latter and the Exchange Member.
   Non-member banks/brokerage firms will receive buy and sell orders from their retail traders clients and send the clients' orders to the system through the Exchange Member that they have a correspondent agreement with.
   Every non-member bank/brokerage will be provided with a standard trading software application as well as a special Non-Member Order Entry Module to enable entering clients buy/sell orders into the system as well as changing or canceling an open client's order entered into the system upon client's request. Such bank/brokerage will receive a special Trades Report module where all of his clients' trades will be detailed.
   For each buy/sell order placed into the system by non-member bank's/broker's client, the bank/broker will receive from a client a per-volume and/or per-transaction fee. On the other hand, such a fee will be paid to the Exchange Member that the non-member bank broker has a corresponding agreement with.
c. Retail Traders (105-108). To gain access to the system, a retail trader will have to open an account with the Exchange Member or non-member bank or non-member Forex brokerage firm that has a non-member correspondent agreement with the Exchange Member. After the trader's account has been setup and all margin requirements have been fulfilled, the trader will receive a trading software application that provides him with an access to the system's centralized foreign exchange market and enables to send orders directly to the exchange.
   The trader's buy and sell orders will be sent to the central processing server through an account that he will hold with an Exchange Member/non-member bank/non-member broker.
   The identity of the end user that has sent a buy or sell order will remain undiscovered and his anonymity remain intact, since only Exchange Member ID will be shown on Bids/Asks and Trades Windows. Retail traders will pay per transaction/per volume commission to broker and/or commercial bank for their services.
      System Trading Rules, Duties and Obligations

There are a set of rules and obligations that will apply to all Exchange Members as well as all non-member banks/brokers and retail traders associated with the Exchange Members.
Commercial banks and Forex brokers-dealers may apply for the system membership by filing its application into the system providing that the applying bank/broker will have all licenses and registrations required by his Central Bank and by relevant country, state and federal authorities. The applying bank/broker should be in stable financial position and without any considerable country/state investigation, regulatory action, civil action or arbitration filed against him.
Non-member commercial banks and brokers-dealers seeking registration with the Exchange Member will file an application with one of the registered Exchange Members. Exchange Member will perform a due diligence process regarding such a bank/broker, including financial and tax status as well as investment objectives and risk profile. Only those banks/brokers fulfilling reasonable due diligence conditions and maintaining a certain minimum net capital will be allowed to trade on the system through the corresponding Exchange Member.
Every Exchange Member must maintain in file information concerning each bank/broker correspondent including his trades information and general financial status information. This information should be sent to the correspondent at the end of each month as well as being available to the correspondent in real-time online mode.
Every Exchange Member maintain in file information on every order sent by it or its correspondents/clients to the exchange and concerning every trade executed with it participation on a buy or sell side of the trade.
Exchange Members must honor all system trades posted by its clients and correspondents.
Exchange Members must post every Bid/Ask request submitted by their clients and correspondents to the exchange including all Bid/Ask order particulars and without any delay or change.
Exchange Members are not allowed to post Bid/Ask orders for the purpose of creating a misleading presentation of market activity in any particular currency pair or in a market, in general.
Exchange Members will send daily, monthly and annual trading activity reports to the system' central processing server.
Failure by an Exchange Member to comply with any of the duties and requirements can cause suspension or cancellation of its membership.
   Security

Security demands must be among the highest priorities of the disclosed system. A comprehensive security measures must be implemented at every step of the trading process to ensure the complete protection of data and trader confidentiality. Advanced authentication and authorization procedures will be established to provide a totally secure trading environment. Security measures will include among others:
Login & password. The trader could login into the trading software application using correct username and password combination authentication.
Communication. In view of the sensitive nature of information, communication with external entities must be done using secure communication channels.
Top-notch security products installed in the central processing server.
   Data Stream

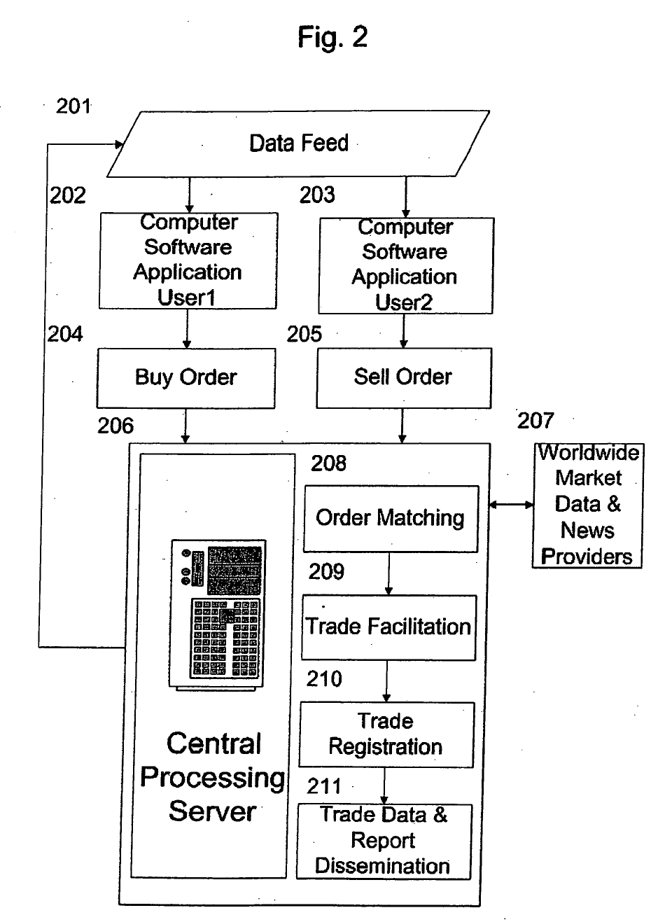

A graphical overview of system's major data streams is provided in FIG. 2.

Each trader's trading software application is integrated in a marketplace network for delivering an online real-time data stream to and from the system to the marketplace. It is both receiving Bids, Asks and Trades data feed from the central processing server (201) and sending buy/sell orders to the marketplace's central processing server (202-203).

The trader logs into the system using his unique username and password login credentials. These login credentials enable the system to recognize that buy/sell orders are coming from a particular system user. The user chooses the portfolio of currency pairs that he wants to trade. The order for each currency pair is sent to the marketplace for execution by comparing its particular parameters with predetermined order parameters (204-205). Upon a change in the quoted price for a security, the system updates all relevant order qualification parameters.

When the trader sends an order to the marketplace using his trading software application, a certain data stream is sent to the central processing server computer and an additional data stream is sent automatically to the Exchange Member and/or the non-member bank/broker that the trader has an account with. When the order is filled fully or partially, or cancelled—the data stream is sent from the central processing server to the trader, to the Exchange Member and to the bank/broker.

All deals from all system's traders are uploaded to the central processing server (206) where they are sorted by currency pair symbol, Bid/Ask price, time and volume. After the orders have been matched on the central processing server, the price is updated. The trader's software application constantly receives an updated real-time data feed for a plurality of currency pairs from the central processing server that includes Bids/Asks data as well as full trades, volumes and time data.

Additionally, the system could be dynamically connected to the worldwide financial market data and news providers in order to receive pricing and news information as an input to be displayed on the trader's software application as well as for disseminating currencies trading data from the system to the worldwide media (207).

Central Processing Server

Order and Trade Recording

All Bid/Ask quotes are dynamically updated in real-time by the central processing server according to the new Bids/Asks entered by one of the Exchange Members and the updated Bids/Asks are displayed on a computer software application Bids/Asks Window. The quote update will reflect the receipt, execution, or cancellation of a customer limit order or other order customer-defined particulars.

The following order information will be recorded at the system's central processing server when buy or sell order is received by it:
Exchange Member ID
Order date and time
Currency pair symbol
Number of lots (trade volume)
Designation of the order as a buy or sell order
Order price, i.e. the price at which the order will be executed
Order type (as detailed hereafter)
Order filling type (as detailed hereafter)
Order expiration (as detailed hereafter)

Buy side and sell side parties to the trade will transmit these order particulars to the central processing server where online order matching will be performed (208). As a result of an automatic order matching process, trade will be facilitated by the central processing server (209). Trade then will be recorded (210) and the following trade information will be recorded at the system central processing server and disseminated to all Exchange Members in the system (211):
Exchange Member ID for the buy side of the trade
Exchange Member ID for the sell side of the trade
Trade date and time
Trade value date (which is normally two days after trade execution date)
Trade price
Currency pair symbol
Trade Quantity

End of day recaps will be additionally provided. Specifically, clearing bank members will be able to receive an end of day recap of all trade details of theirs and their correspondents/clients.

Clearing and Settlement

The disclosed system could be implemented using either of two different clearing and settlement methods. Clearing of trades involve verifying each trade against exposure, accepting/rejecting and netting the trades prior to trade settlement.

Central Clearing and Settlement Banking System

The first and probably the most advanced method involve a use of a centralized order clearing and settlement system. Such system will be founded by the Exchange Members that will create a Central Clearing and Settlement Banking System (CCSBS) by signing an appropriate agreements and depositing their funds into the CCSBS account. Using this system, all trades will be settled in real-time on a payment versus payment basis. In such a system each Exchange Member may act as a CCSBS-Clearing Member, i.e. he will clear and settle his own or his clients transactions in all currency pairs by himself, or he may act as a CCSBS Non-Clearing Member, i.e. he will clear and settle transactions through the facilities of a CCSBS-Clearing Member by signing a correspondent clearing arrangement with such Exchange Member. All system's CCSBS-Clearing Members must maintain and deposit to the CCSBS sufficient funds for performing transactions.

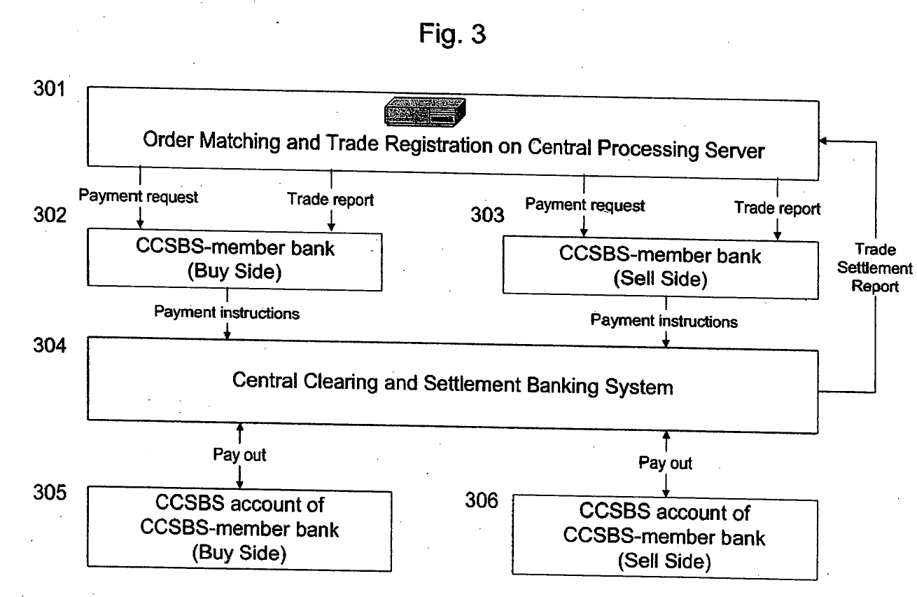

The CCSBS-based system is shown in FIG. 3.

After the trade has been registered on the disclosed system central processing server (301), a special Trade Report will be sent to the CCSBS-Clearing Member participating in buy and sell sides of the trade together with the payment request (302, 303). These members will transmit to the CCSBS their payment instructions in accordance with the trade particulars (304). Trade settlement between two CCSBS—Clearing Members will be performed inside CCSBS (304) which will perform the pay out to both Exchange Member accounts in accordance with the payment instructions during a few hours period pre-determined at the moment of CCSBS creation, which, in effect, will complete the trade settlement process (305, 306). During funds transfer process, the CCSBS will simultaneously credit both Exchange Member accounts with the funds due according to the trade details, thus eliminating the risk that one side may not receive payment. Upon trade settlement CCSBS will send a trade settlement report to the central processing server. From the central processing server the trade settlement information will be disseminated to the CCSBS-Exchange Members participating on buy and sell sides.

There is an existing foreign exchange settlement bank called CLS (Continuous Linked Settlement) Bank active on a Forex marketplace from 2002. CLS provides continuous linked settlement services to ensure final and simultaneous settlement of cross-currency financial transactions by the means of payment versus payment basis where trade settlement takes place during a five-hour window. During this time window settlement instructions for a particular date are settled and funds are requested to be paid in and are paid out by CLS Bank.

CLS Bank could be used as a settlement entity to the disclosed system exchange.

Exchange Member Clearing System

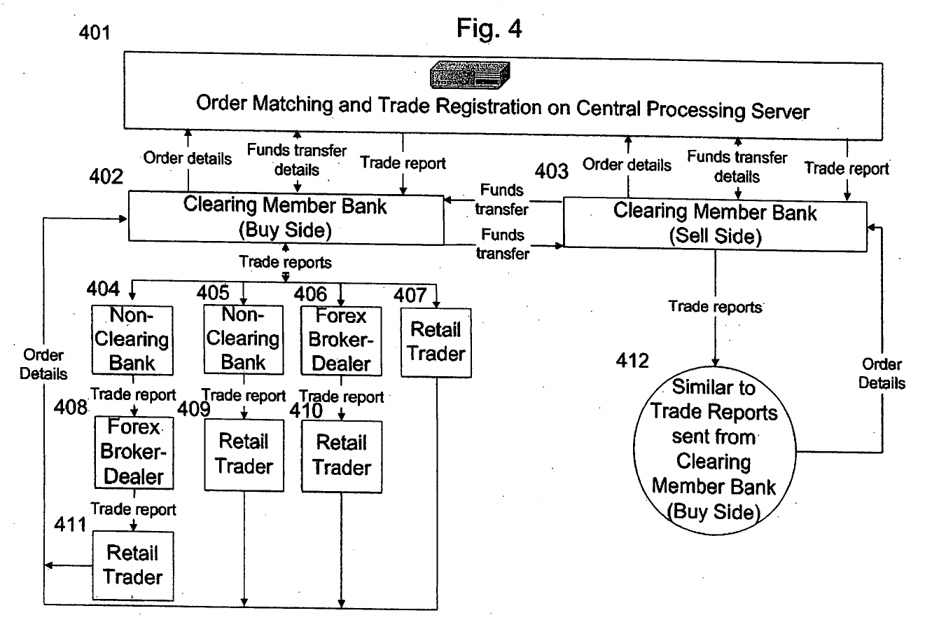

The disclosed system could also be implemented under another clearing and settlement system which is a Member Clearing and Settlement System. This system is graphically illustrated in FIG. 4.
Order matching and trade registration has been performed on the central processing server (401).
Each Exchange Member may act as a clearing Exchange Member (402-403), i.e. it will clear and settle its own or its clients transactions in all currency pairs by itself, or it may act as a non-clearing Exchange Member, i.e. it will clear and settle transactions through the facilities of a clearing Exchange Member admitted into our system by signing a correspondent clearing arrangement with such a member. A clearing Exchange Member will be obligated to accept and clear each trade that the system identifies as having been conducted by that Exchange Member and its clients or by non-clearing Exchange Member (and its clients) entered into the clearing agreement with that Exchange Member.
To complete the trade settlement, clearing Exchange Members on the buy and sell sides of the trade will wire funds one to another in order to pay for its own or its correspondent's trade and according to the currency pair traded. Funds transfer details will be sent to the central processing server.
Clearing Exchange Members will transmit last trade reports of transactions to it correspondents and clients immediately after the trade is cleared and settled. If the retail trader is a client of non-member broker/bank who is a correspondent of non-clearing Member which is a correspondent of a clearing Member, then the Trade Report is sent to the non-clearing member, to the non-member bank/broker and to the trader himself (404, 408, and 411). If the retail trader is a client of non-clearing Member which is a correspondent of a clearing Exchange Member, then the Trade Report is sent to the non-clearing Member and to the trader himself (405 and 409). If the retail trader is a client of non-member bank/broker who is a correspondent of a clearing Member, then the Trade Report is sent to the non-member bank/broker and to the trader himself (406 and 410). If the retail trader is a client of a clearing Exchange Member then the Trade Report is sent to the trader himself (407). Trade Reports are similarly sent from the clearing Exchange Members on the buy and sell sides of the trade (412).
The system clearing Exchange Members will utilize the risk management procedures to establish a daily margin threshold for each correspondent non-clearing Exchange Member and to it non-member clients. The clearing Exchange Member will cease receiving Bid/Ask orders from the corresponding banks, brokers and traders when those equal or exceed the margin threshold and decline upcoming Bids/Asks until the margin threshold norm is restored.
   Trading Software Application

Every system participant will receive a trading software application interactively and dynamically connected to the central processing server. Using this software application the trader will view orders, trades and prices market data available from the central processing server as well as send Buy/Sell orders to this server. The trader has a number of windows that he can access from the main menu. The main windows are: Bids/Asks Window, Orders Window, Trades Window, Prices Window, Market Data and News Window. Different informational and order-related windows could be similarly applied.

The trader can customize each of the windows by changing its text and background colors, font, font size, and font characteristics.

Bids/Asks Window

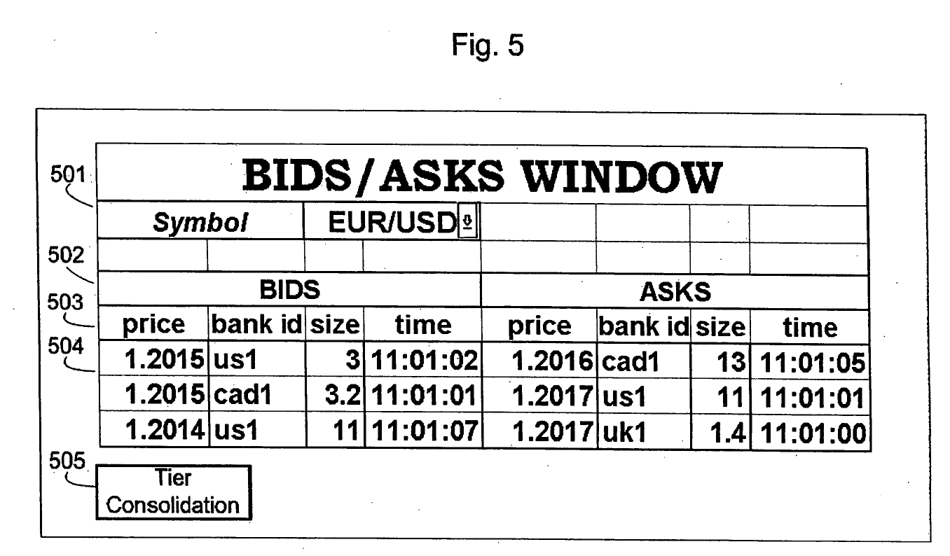

Each Exchange Member is receiving buy/sell orders from their clients and sending it to the central processing server from where it is displayed in a trading software application. Every buy/sell order sent to the system is displayed on the Bids/Asks Window in a form of Bids and Asks real-time quotations as schematically illustrated in FIG. 5.

To view Bids/Asks for any currency pair, the trader chooses a currency pair from a list of available currency pairs (501). Bids are displayed on the left side of the window and Asks are displayed on the right side (502). There are eight columns in each row showing different order details, four in the Bid side and four in the Ask side (503): Bids and Asks prices will be shown in Price columns; Buy ID and Sell ID columns will show the ID of a Exchange Member whose correspondent or client placed the buy or sell order (504 shape of a FIG. 5); volume (money amount) of the posted Bids and Asks is shown in Buy Size and Sell Size columns and expressed in millions of currency units; an the exact time (in hours, minutes and seconds) of when the Bid/Ask was posted or last updated will be shown in Bids and Asks Time columns. The columns in the Bids and Asks pans are identical.

After posting buy or sell order displayed on the Bids/Asks Window, any Exchange Member would not be eligible to withdraw or to edit it unless the underlying buy or sell order have been changed or cancelled by the trader (Exchange Member client or correspondent).

Full depth of Bids/Asks pricing is available to the traders from this window as Bids and Asks for all price levels are displayed for each currency pair (504). The Bids and Asks data is sorted to price tiers by Bid/Ask price when the highest Bid price is shown in the highest row and the lowest Bid in the lowest row. For the Asks data the Best Ask, i.e. the lowest Ask price is shown in the highest row and the highest Ask in the lowest row. Within each price tier the Bids/Asks data is sorted by the time of their posting when the earliest Bid is shown in the highest row and the latest in the lowest row within the price tier.

The trader has an option of limiting the number of price tiers he wishes to see. Using Tier Consolidation option (505) he will be able to consolidate all Bids/Asks and their quantities posted by different Exchange Members for the same price tier. For example, in 504 there are two banks each posting Bids for EUR/USD at 1.2015, one for 3 millions and another for 3.2 millions. Clicking on the Tier Consolidation button will consolidate first two rows and as a result unit 504 of FIG. 5 will display 6.2 million of EUR/USD at 1.2015. Naturally, Member ID would not be shown here since Bids and Asks from all Exchange Members have been consolidated.

Different price tiers are defined and separated by the background color. For example, if there are two Exchange Members posting Bids for EUR/USD at 1.2015 and one Exchange Member posting Bids for EUR/USD at 1.2014, there will be two differently colored tiers on the Bids/Asks window: the first will include two rows representing two Exchange Members at 1.2015, and the second will include one such row representing Bid at 1.2014.

Clicking on any specific Bid or Ask will upload Order Window from which the trader can send buy or sell order after filling and/or editing different order parameters.

Orders Window

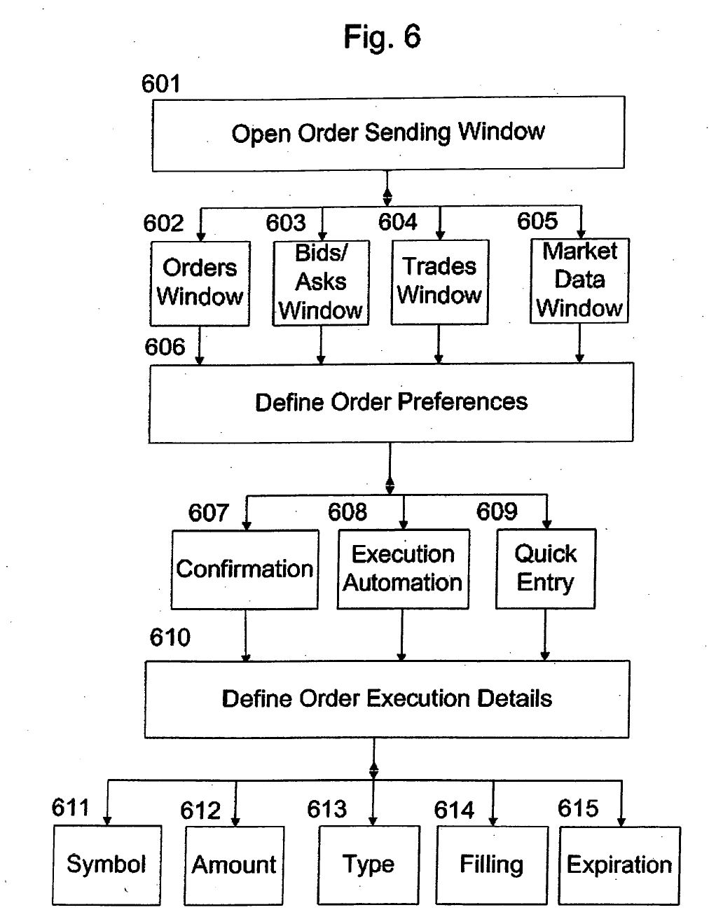

A graphical overview of order sending process is provided in FIG. 6.

To place an order, the trader would need to specify several order parameters in the Orders Window of the trader software application, including currency pair symbol, order amount, type, expiration and others.

To send an order the trader has to open one of the order sending windows (601). The order could be placed from the Orders (602), Bids/Asks (603), Trades (604) and Prices Windows (605). The trader has an option of specifying and editing all order parameters from all these windows. Additionally, closing of an open trade is available from an Account Manager window.

Order Confirmation

The trader can start specifying his default order preferences (606) by choosing one of the order confirmation options. The trader can choose here if he wishes to send an order with or without confirmation (607). If “confirmation” option has been chosen the Order Confirmation Window will appear after order sending. If “without confirmation” option has been chosen, the order will be sent for instantaneous execution after buy or sell buttons have been pressed and without confirmation.

Order Execution Automation

The trader has an option of choosing the level of order execution automation (608). To do so, the trader will need to subscribe and to connect to one of the automatic execution platforms. The Makor Company has developed such a platform and subscription to the platform will be available to all system's traders. Every trader who is not a subscriber to automatic execution platform will have a regular non-automatic execution option at his disposal.

After subscribing to Makor's automatic execution platform, the trader will have three execution choices available to him. He can choose completely automatic trading option where all trades generated by the trading software are transferred to exchanges without his further confirmation or intervention; in such a case the trader has to choose from a list of prepared trading strategies which strategy or strategies he prefers to use or to add his own trading strategy to the trading software. Buy/sell signals generated by the abovementioned trading software will be sent to system's centralized marketplace using automatic execution option, if the user chooses “Automatic” in execution options interface. If the trader chooses semi-automatic order execution option, then when buy/sell signal has been generated by the trading software, it is transferred to system's centralized marketplace after the user's Order Confirmation. In such a case, a special Order Confirmation window will appear, and the user will have to confirm the order by clicking on order confirmation button. Third order execution automation option is a regular execution option: here the user receives buy/sell signals from the trading software and he transfers them to the marketplace by manually typing order details and execution parameters.

The trader can set different order execution automation levels for different strategies.

Quick Order Entry

The trader can send trades to the system's marketplace using Quick Order Entry option (609). To do so, the trader first activates “Allow Quick Order Entry” option at order parameters section. After activating this option, the order will be sent without Order Confirmation and according to order default parameters. For example, after defining order defaults as an AON GTC order of 10 lots, by double-clicking on a Bid price from Bids/Asks screen for EUR/USD, the user can send an AON GTC Sell order for 10 lots of EUR/USD.

Currency Pair Symbol

To start the order definition process for a particular order (610), the trader specifies which currency pair he wishes to trade by typing the currency pair symbol in the Symbol field (611).

Order Amount

The user specifies the money amount (in millions of base currency) that he wishes to buy or to sell for the selected currency pair (612).

Order Type

After specifying currency pair symbol and order amount, the trader chooses a type of Order Price (613). First, the trader chooses if he wishes to buy or to sell the selected currency pair. Then, the trader can choose to use Market Order, Limit Order, Best Bid/Ask Order, Stop Market Order, Stop Limit Order, Trailing Stop Order, Close All Order. All other types of orders could be easily and similarly implemented.

Market Order is sent without specifying an exact execution price; it is sent and executed at a price available under current open market conditions. I.e. Market Buy Order is executed at an Ask price available at the market at a time of order receiving by the central processing server. Similarly, a Market Sell Order is executed at a Bid price.

Limit Order is an order to buy or sell at a designated price. This order will be executed at the specified limit price or better. For example, Buy Limit order for EUR/USD with price limit of 1.2015 will be executed if and when Best Ask for this currency pair symbol will be at 1.2015 or any price lower than 1.2015. Similarly, Sell Limit order for EUR/USD with price limit of 1.2015 will be executed if and when Best Bid for this currency pair symbol will be at 1.2015 or any price higher than 1.2015.

Best Bid/Ask order is a Limit order with a price equals the Best Bid or Best Ask price currently posted on a market.

Stop Market order is an order that becomes a Market order only after the specified price level has been reached. This order is used to either enter a new trade or to exit an open trade. The Stop Order does not guarantee that the trader is going to Enter or Exit a position at an exact price, because as stated, when the price is reached or penetrated, the order becomes a market order. A Buy Stop order is placed above the current market and is selected only when the market is bid at or above, the stop price. A Sell Stop order is placed below the current market and is selected only when the market is offered (Asked) at or below, the stop price. Once the stop order is selected, the order is treated like a market order and will be filled at the best possible price. Stop orders are commonly used to enter a market when the market is moving in that direction, protect profits, or to attempt to limit losses.

Stop Limit order: a Stop Limit order lists two prices and is an attempt to gain more control over the price at which the stop is filled. The first part of the order is written like the above Stop Order. The second part of the order specifies a limit price. It indicates that once the stop is triggered, the order will not be filled beyond the limit price. Stop Limit orders should usually not be used when trying to exit a position.

Trailing Stop order is a Stop Market order that follows market price with a difference of the specified trail amount, creating a Stop Market order, as the market price moves away from the original price. Here the trader has first to choose an amount of this “following”—trailing amount. For example, for EUR/USD if the user chooses a trailing amount of 10 pips when the current price is 1.2015, then the trigger price is 1.2005 for Buy orders and 1.2025 for Sell orders. The Trailing Stop order will place a Market Sell Order once current market price falls to 1.2005. The Trailing Stop order will place a Market Buy Order once current market price increases to 1.2025. Trailing Gain order is similar to Trailing Stop order and it differs in that a Stop Market order is generated when the order is gaining a specified trailing amount. For example, if the user chooses a trailing amount of 10 pips when the current price is 1.2015, then the trigger price is 1.2025 for Buy orders and 1.2005 for Sell orders.

Close All order is an order that closes all open positions of the trader for all currency pairs.

Order Filling Options

Here the trader chooses if his order could be executed on a Partial execution basis or All-or-None (AON) execution basis (614).

Partial execution order can be filled partly. Sometimes, one Partial execution order is executed as several Partial execution orders. For example, if the user places a Partial Buy order of 3 million, his order could be executed as two Partial execution orders, one of 1.2 million and second of 1.8 million.

All-or-None order is an order to be executed in its entirety or not executed at all.

Order Expiration Options

Here the trader chooses from three different order expiration choices (615).

IOC order (Immediate-Or-Cancel)—is an order requiring that all or part of the order be executed immediately after it has been brought to the market. Any portions not executed immediately are automatically cancelled.

GTC order (Good-Till-Cancelled)—is an order that remains in force until executed, or cancelled by the user. This type of orders is applicable when user wishes to be engaged in a non-automatic execution option.

Day order is an order that, if not executed, expires at the end of the trading day, which could be set as 00:00:00 GMT.

Order Sending

After the order has been sent, an Order Confirmation Window appears with three following options:
Confirm—confirming the order and sending it for market execution;
Edit—returning to Orders Window for subsequent order editing,
and Cancel—canceling the order. The user can cancel orders that are not executed or cancel a part of the order that has not been not executed in a case of partially filled order.

Clicking on the Cancel All button cancels all non-executed and partially filled orders.

Trades Window

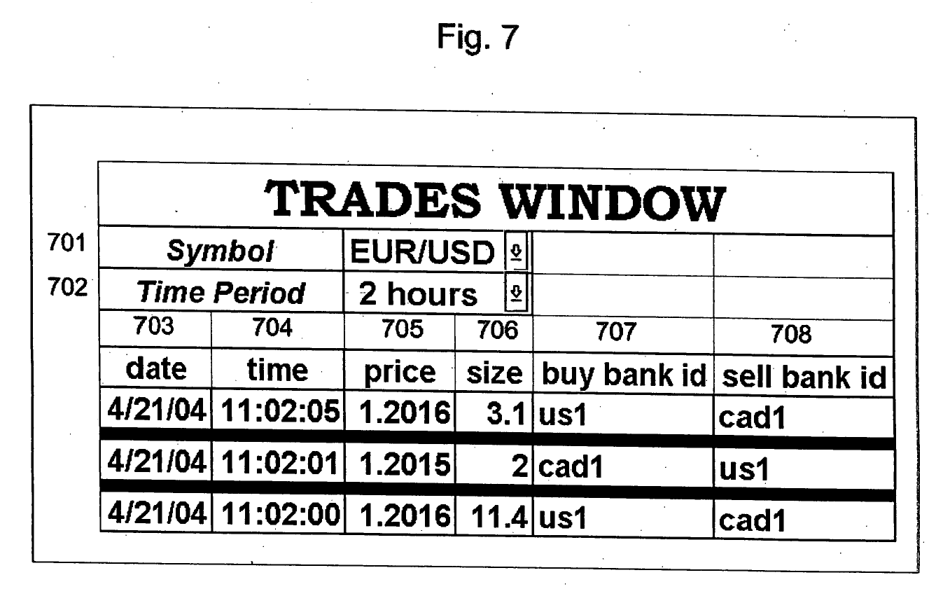

A graphical illustration of the Trades Window is provided in FIG. 7.

The Trades Window displays all trades executions for a particular currency pair in a particular trading period. The trader chooses the currency pair symbol (701) and time period that he wishes to see the data for. The trader specifies the data period by either choosing a time period in minutes, hours or days, or by specifying the Start GMT Time and Start date information (702).

The Trades Window displays one row for each trade with trades sorted by times of their execution with the latest executed trade shown in the highest row. There are six columns in each row showing different trade details: Date, expressing the date of the trade (703); Time, expressing the exact time (hours, minutes and seconds) of the trade execution (704); Price, expressing the price of the trade done (705); Size, expressing the volume of the trade done (706); Buy Member ID (707) and Sell Member ID (708) showing Member ID of the Exchange Members participated in the Buy and Sell sides of the trade done.

The Trades Window may be shown adjacent to the Bid/Asks Window to allow the trader to see relevant past trades information together with current Bid/Ask data, to assist in his trading decision.

Orders Window may be shown adjacent to the Trades Window to allow quick order placing.

Prices Window

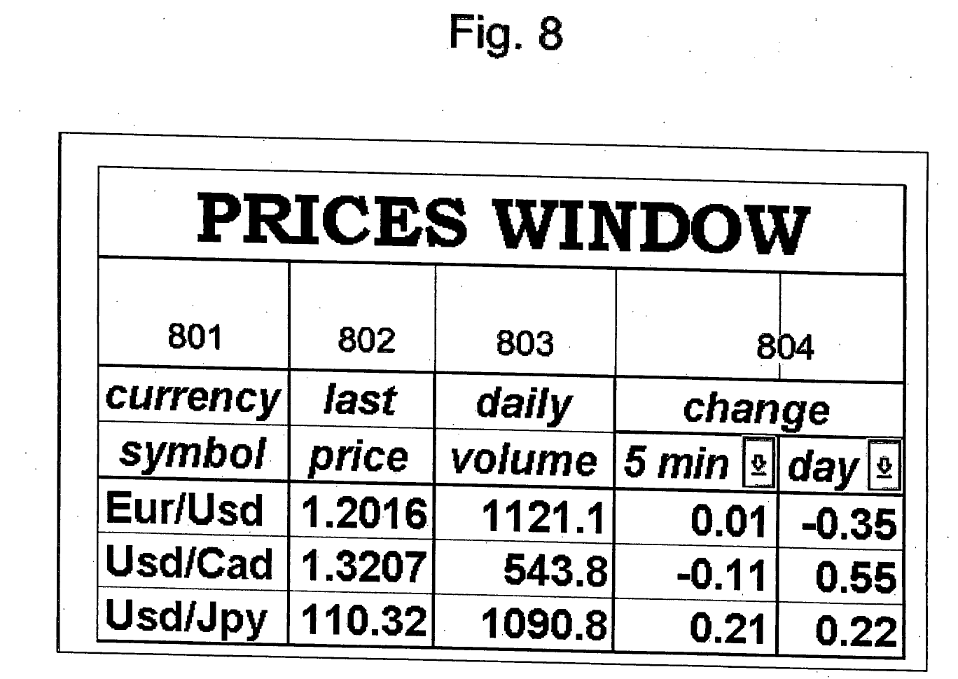

The Prices Window displays prices for all currency pairs available on the system. A graphical illustration of the Prices Window is provided in FIG. 8.

The Prices Window displays one row for each currency pair as follows: Currency Symbol column describes an abbreviation of the currency pair symbol (801); Last Price column shows the price of last trade executed for that currency pair (802); Daily Volume shows the total volume of all trades done for the particular currency from the beginning of the day (803); Change column shows a change in currency pair price in different trader-defined time periods (804).

The Prices Window may be open adjacent to the Bid/Asks Window to allow the trader to see relevant past trades information together with current Bid/Ask data, to assist in his trading decision.

Orders Window could be open adjacent to the Prices Window to allow quick order placing.

Account Manager Window

A record of all trading activities of every trader is maintained on the central processing server. From the central processing server it is displayed on the Account Manager Window of the trading software application. This window is provided to allow the trader to track and analyze open positions, to view his current profit/loss numbers and an account history as well as his overall account balance and profit/loss information. Specifically, this window includes information on current holdings for each currency pair, account cash and securities positions, profit/loss parameters per currency pair and per portfolio, including realized profit/loss and non-realized profit/loss, maximal investment limit (margin) allowed to the trader and a detailed trades data for each trade executed by that trader.

The information in the Account Manager Window is updated in real-time as the Window is dynamically and interactively connected to the central processing server.

Upon execution of each buy/sell order, it goes to the Account Manager Window according to order execution price and quantity parameters. The profit/loss results are then displayed in the Account Manager Window.

As market quotes change or trades occur in the markets, the system will update market data, account and portfolio holdings for all relevant currency pairs.

To fulfill the requirements of brokers-dealers hedge funds and account managers, the multi-account feature will enable the trader that manages several trading accounts to send one buy/sell order that will then be split between accounts registered as client accounts of that trader according to order allocation details. I.e. if an account manager has two accounts for five millions of US dollars each and he sends an order for two millions of US dollars, then the order will be accounted and registered as two orders of one million US dollars each.

Orders Window may be shown adjacent to the Account Manager Window to allow quick order placing.

Market Data and News Window

A graphical presentation of the pricing data received from the central processing server will be presented in this window by a charts feature to allow the trader to view a visual illustration of the price movement of a particular currency pair. A number of standard charting features are provided: different chart types, such as line, bar and candlestick chart are available as well as customizable bar size. Multiple layers charting provides an option of viewing several charts simultaneously. A variety of advanced technical studies can be applied to the charts, including technical indicators, timescale and period settings, draw trend and Fibonacci lines, etc.

A news feed will be integrated into the system, providing a trader in real-time with the top business and political news as well as important global economy indicators. The trader will have an option of customizing news data and of filtering news articles by different fields.

Market summaries and earnings reports could be further presented based on potential agreements with worldwide news-providing agencies.

### Embodiments

Additionally to the main embodiment of the disclosed system described in the “Detailed Description of the Invention” paragraph, the system may have alternative embodiments. The main is as follows.

Automatic Execution Trading Software

The invented system could be implemented with the automatic execution trading software that will assist the trader in choosing his preferred trading strategy and executing it automatically and without human intervention patent application Ser. No. 10/613,467, filed on Jul. 3, 2003, entitled “MACHINE LEARNING AUTOMATIC ORDER TRANSMISSION SYSTEM FOR SENDING SELF-OPTIMIZED TRADING SIGNALS”, filed by David Myr and assigned to Makor Issues & Rights Ltd. could provide a strong foundation for such embodiment.

The trading software of this embodiment will have all the regular features of the usual trading software application described in this patent and will be provided as an additional module for such software application and will be available to all system users.

In such trading software the trader will have an ability to build, evaluate and test a variety of trading strategies and trading indicators through the Strategy Builder facility. This facility has a variety of pre-programmed trading strategies and trading indicators as well as an option for adding new trading strategies and indicators by combining existing ones, modifying them or by writing his own strategies and indicators using Easy Language for technical indicator programming. Such trading software will produce buy/sell signals according to one or more trading indicators and/or trading strategies, both in a backtest mode or in a real-time mode. Using optimization and machine learning options, the trader can optimize trading strategies/indicators parameters and perform self-optimization. After a satisfactory amount of testing, the user can switch this software into a real-time and real-money mode, thus using it for producing buy/sell signals that can be transmitted for real-time execution to the system's central processing server via the automatic execution module described hereafter. To start using this trading software, the trader has to choose the portfolio of currency pairs that he wants to trade and to enter appropriate currency pairs symbols into the portfolio box. Then, he has to choose his preferred trading strategy or trading indicator for the selected portfolio of currency pairs from the list of build-in and ready-to-use trading strategies programmed into the software or by writing a new indicator and incorporating it into a trading strategy. The trader can base his trading decisions either on one trading strategy or a combination of strategies. He can also make changes to the build-in strategies by pressing Modify Strategy button and/or by adding technical indicators to the chosen strategy. Another significant feature of the trading software module is an Optimization Facility. Using self-optimization and machine learning features built into the system is an another option for building a potential profitable trading strategy. Self-optimization and machine learning mechanism is taking previously determined optimal strategies, indicators, their parameters, components and trading results as an input for building a new model that will produce new improved buy/sell signals. To complete the strategy building process, the trader can choose to run the trading strategy with or without optimization of different parameters and rules built into trading indicators and, subsequently, trading strategies.

As a result of strategy building process, the trader has a ready-to-use system that generates buy/sell signals for currency pairs previously entered into the portfolio. The next step would be specifying certain trading conditions in regard to the chosen strategy, such as period, start and finish dates of back testing and various optimization parameters. The trader can now back test the trading strategy using wide array of back test specific parameters available from the Backtest Facility. The results are then recorded in a special strategy evaluation report to enable the trader to assess the performance of each strategy based on specific performance metrics.

After sufficient amount of back testing, the user can either let the system go “live”, i.e. let it generate real-time buy/sell signals on currency pairs in the portfolio or to engage in a Paper Trading activities. Paper Trading means that automatic order feature emulates sending orders (automatically and, completely, without human intervention) according to the chosen trading strategy to the central processing server and receiving confirmations of executed orders without real money invested.

When the trader decides to be engaged in real money trading activities, a buy/sell signal generated by the trading software goes to the central processing server for market execution using an automatic execution module. By doing so, orders could be transmitted automatically and completely without human intervention according to trader-predefined order qualification and execution parameters (as described in the foregoing Orders Window paragraph). The trader chooses the level of order execution automation when he has three execution choices as described in the foregoing Order Execution Automation paragraph. After a buy/sell signal is generated by the trading software, may it be back testing, Paper Trading or real money trading, it is accounted in the Account Manager module. In the case of back testing or Paper Trading, trading signal is transferred directly to the Account Manager. In real money trading, the buy/sell signal, or more appropriately, buy/sell order is transferred to the central processing server first, and, then, upon execution, it is being registered in Account Manager according to order execution price and quantity parameters.

To fulfill the requirements of brokers-dealers, hedge funds and account managers, the multi-account feature will enable the trader that manages several trading accounts to send one buy/sell order that will then be split between accounts as described in the Account Manager Window paragraph.

Market Data Feed Provider Agency

An additional possible embodiment of the disclosed system is to disseminate the orders and trades market data generated by the system to worldwide news agencies.

As detailed above, currently there is no central currency symbol price available in Forex market. One of the main aims of the disclosed system is to centralize Forex price rates by providing one price used by all Forex market participants. Currently there are services such as Reuters Indicative Rates service that offer a so-called Indicative Interbank Rates derived from the interbank trading platforms. While offering a pretty accurate indication of market prices, still there is no one centrally determined currency pair rate available on current Forex marketplace.

Using the disclosed system, the orders and trades data in different display-formats could be distributed in real-time from the central processing server to the various financial, business and world news and market data providers (such as Esignal and Lycos-Quote). That could be executed by using TCP/IP protocol and multicast means or by other similar technological means. Connection to one of the data feed providers servers could be established using a set of Application Programming Interface (API) functions.

The orders and trades market data registered and stored on the central processing server could also be collected on a special server computer. All real-time and historical data from that computer could be provided to users through the Internet or by CD-Rom/DVD means.

It will, of course, be realized that numerous modifications and variations from the illustrated embodiments may be employed without departing from the inventive concept herein.

1. A system, method and computer software application for centralized foreign exchange spot currency trading in which order matching is centrally performed on a central processing server and in which commercial banks, brokers-dealers and individual traders trade on a centralized foreign exchange marketplace. They comprise the following:
Central processing server that receives buy and sell orders and their particulars, automatically matches the orders and facilitates trades transactions, registers and stores trades details, disseminates trades execution details reports, receives market data from a variety of worldwide market data providers, and sends orders and trades market data to a variety of interested worldwide market data providers;
Computer software application interactively connected to the central processing server and provided to all system users that receives and displays information from the central processing server regarding buy/sell orders and their particulars, and also trades and their particulars on special graphic user interfaces, provides system users with a means to send buy/sell orders to the central processing server and displays relevant market data information received from the central processing server.

2. The system, method and computer software application of claim 1 wherein the type of the transaction is a foreign exchange forward.

3. The system, method and computer software application of claim 1 wherein commercial banks and Forex brokers-dealers become an Exchange Members by complying with the system regulations and with all regulations from their respective government central banks.

4. The system, method and computer software application of claim 1 wherein Exchange Members are divided into clearing members, i.e. members performing clearing and settlement for themselves and their correspondents, and non-clearing members, wherein non-clearing members sign a special clearing and settlement agreement with one of the clearing members in order to trade in the system.

5. The system, method and computer software application of claim 1 that could be implemented by either of two different clearing and settlement methods:
A centralized Central Clearing and Settlement Banking System (CCSBS) founded by the Exchange Members by signing appropriate agreements and depositing their funds into the CCSBS account. This is a payment versus payment system wherein in order to settle a trade the funds will be transferred between CCSBS account of a Exchange Member participating on buy side of the trade and CCSBS account of a Exchange Member participating on sell side of the trade;
A Members Clearing and Settlement System wherein in order to perform the trade settlement, clearing Exchange Members on the buy and sell sides of the trade will wire funds one to another in order to pay for their own or their correspondent's trade and according to the currency pair traded.

6. The system, method and computer software application of claim 1 wherein non-member commercial banks and foreign exchange brokers-dealers sign special non-member correspondent agreements with the Exchange Members and deposit funds in the Exchange Members' accounts in order to receive a computer software application in claim 1 and to trade on the system's centralized foreign exchange through their respective Exchange Members.

7. The system, method and computer software application of claim 1 wherein individual retail traders receive a computer software application in claim 1 and trade through that computer software application directly on the centralized system through an Exchange Member or by signing special client-correspondent agreements with a non-member commercial bank or non-member foreign exchange broker-dealer, which previously signed non-member correspondent agreements with one of the Exchange Members.

8. The system and computer software application of claim 1 interacting with the central processing server, further comprising means for displaying Bid/Ask orders and their particulars for all price levels on a tabular view graphical user interface.

9. The system and computer software application of claim 1 interacting with the central processing server, further comprising means for displaying executed trades prices, sizes and other particulars on a tabular view graphical user interface.

10. The system and computer software application of claim 1 interacting with the central processing server, further comprising means for choosing buy/sell order particulars using a graphical user interface.

11. The system and computer software application of claim 1, interacting with the central processing server, further comprising means and, specifically, a graphical user interface for sending buy/sell orders from a trader's computer software application to the central processing server.

12. The system and computer software application of claim 1, interacting with the central processing server, further comprising means of choosing order type, order execution preferences and other execution details to suit trader's individual trading preferences and style.

13. The system and computer software application of claim 1, interacting with the central processing server, further comprising means of sending buy/sell orders to the central processing server automatically and without human intervention.

14. The system and computer software application of claim 1, interacting with the central processing server, further comprising means of sending buy/sell orders to the central processing server by double-clicking on a relevant bid or ask price—quick order entry method.

15. The system and computer software application of claim 1, interacting with the central processing server, further comprising means of storing, accounting and displaying trader's profit/loss information in accordance to order execution details.

16. The system and computer software application of claim 1, interacting with the central processing server, further comprising means and, specifically, a graphical user interface for displaying market quote data in a tabular view and in a graphical presentation in a chart view from the central processing server.

17. The system and a computer software application of claim 1, interacting with the central processing server, further comprising means and, specifically, a graphical user interface for displaying market news data from the central processing server.

18. The method of presentation of foreign exchange buy/sell orders data displayed by means of a graphical user interface (illustrated by FIG. 5) for showing buy/sell orders prices for all price levels and other order particulars of a previously chosen currency pair symbol in a special window (called Bids/Asks Window) as follows:
(a) There are eight columns in each row showing different order details, four in the Bid side and four in the Ask side: Price columns showing Bid and Ask prices; Buy ID and Sell ID columns showing the ID of an Exchange Member from whose client the buy or sell order has been placed; Size columns expressing the size of the posted Bids and Asks; Time columns expressing the exact times (hours, minutes and seconds) of when the Bid and Ask were posted or last updated.
(b) Bids are displayed on the left side of the window and asks are displayed on the right side of the window;
(c) Bids and asks are displayed for all price levels with different price tiers being defined and separated by the background color;
(d) Bids and asks data is sorted by Bid/Ask price whereas within each price tier the Bids/Asks data is sorted by the time of posting;

19. A method of presentation of foreign exchange trades data, displayed by the means of a graphical user interface (illustrated by FIG. 7) for showing executed trades prices and other trade particulars in a special Trades Window as follows:
(a) There are six columns in each row showing different trade details: Date, expressing the date of the trade; Time, expressing the exact time (hours, minutes and seconds) of the trade execution; Price, expressing the price of the trade done; Size, expressing the volume of the trade done; Buy Member ID and Sell Member ID showing Member IDs of the Exchange Members participated in the buy and sell sides of the trade done;
(b) Each trade is displayed at a different row in a table;
(c) Trades are sorted by execution times.
